(19) United States
(12) Patent Application Publication
(10) Pub. No.: US 2021/0323354 A1
(43) Pub. Date: Oct. 21, 2021

(54) TIRE WITH CUT PROTECTOR BELT STRUCTURE

(71) Applicant: The Goodyear Tire & Rubber Company, Akron, OH (US)

(72) Inventors: Leonard James Reiter, Ravenna, OH (US); Robert John Boehlefeld, Brecksville, OH (US); Ceyhan Celik, Stow, OH (US); James Gregory Gillick, Akron, OH (US); Andrew Robert Ondo, Pulaski, PA (US); David Charles Wagner, Wadsworth, OH (US); Jimmy Lee Richads, Rootstown, OH (US); Christopher Ryan Self, Akron, OH (US); Michael William Schellenberger, II, Fairlawn, OH (US); Kiyoshi Ueyoko, Copley, OH (US)

(21) Appl. No.: 17/067,825

(22) Filed: Oct. 12, 2020

Related U.S. Application Data
(60) Provisional application No. 63/011,358, filed on Apr. 17, 2020.

(51) Int. Cl. B60C 9/00; B60C 9/20

(52) U.S. Cl. CPC B60C 9/0057; B60C 9/0064; B60C 9/0042; B60C 9/2003

(57) ABSTRACT

A tire, preferably an aircraft tire has a cut protector belt formed of a monofilament reinforcement cord. The cut protector belt is preferably formed by helically winding a monofilament cord, wherein the monofilament cord is formed of nylon, and wherein the cross-sectional shape is not round, and is preferably obround or has a flat surface

### FIELD OF THE INVENTION

The invention relates generally to tires and more particularly to heavy duty tires, such as truck, bus or aircraft tires.

### BACKGROUND OF THE INVENTION

Aircraft, truck or bus tires are typically retreaded in order to reuse the large and complex tire carcass multiple times. However, the treads of truck, bus or aircraft tires may be subject to frequent punctures from stones or other sharp objects in the road or runway surface. The frequency and severity of punctures may cause the tire carcass to be scrapped. Cut protector belts are typically used to try and prevent the carcass from being damaged. However, cut protector belts are often not stiff enough to prevent the damage to the carcass. The sharp object tends to move the belt out of the way in order to pierce the carcass. Thus an improved cut protector belt is desired, which can be used on new or retreaded tires to improve the service life of the tire carcass.

### SUMMARY OF THE INVENTION

The invention provides in a first aspect a tire having a cut protector belt located radially outward of a main belt structure, wherein the cut protector belt is a zigzag belt structure formed by winding a monofilament cord from a first lateral edge to a second lateral edge in a zigzag manner to form an integrally formed two layer of cords, wherein the cross-sectional shape of the monofilament cord is not round. Preferably, the monofilament cord is obround.

### Definitions

“Aspect ratio” of the cord means the ratio of its height (H) to its width (W) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Lateral” means an axial direction.

“Lateral edges” means a line tangent to the axially outermost tread contact patch or footprint as measured under normal load and tire inflation, the lines being parallel to the equatorial centerplane.

“Monofilament” means a cord having only one filament.

“Obround” means a cross-sectional shape having two opposed semicircles connected by parallel lines tangent to their endpoints.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by a shape with adjacent grooves.

“Tread Arc Width” means the arc length of the tread as measured between the lateral edges of the tread.

“Zigzag belt reinforcing structure” means a belt structure formed of at least two layers of cords interwoven together wherein a ribbon of parallel cords having 1 to 20 cords in each ribbon are laid up in an alternating pattern extending at an angle typically between 5° and 45° between lateral edges of the belt, and more preferably between 3 and 11 degrees, and most preferably between 5 and 11 degrees.

### BRIEF DESCRIPTION OF THE DRAWINGS

The invention will be described by way of example and with reference to the accompanying drawings in which:

FIG. 1 illustrates a cross-sectional view of one half of a tire of the present invention;

FIG. 2A is a close-up perspective view of the upper portion of FIG. 1 showing the cut protector belt and belt package of the present invention, while FIG. 2B illustrates a closeup view of the cut protector belt monofilaments;

FIG. 3A illustrates a tire drum wherein a zigzag belt structure is being formed from winding a strip at each lateral ends of the drum;

FIG. 3B illustrates a cross-sectional view of a reinforced strip with parallel reinforcements;

FIG. 4 illustrates the zigzag belt structure during formation;

FIG. 5 illustrates an obround cross-section of a monofilament of the present invention;

FIG. 6 illustrates an oval cross-section of a monofilament of the present invention; and

FIG. 7 illustrates a rectangular cross-section with rounded corners of a monofilament of the present invention.

### DETAILED DESCRIPTION OF THE PRESENT INVENTION

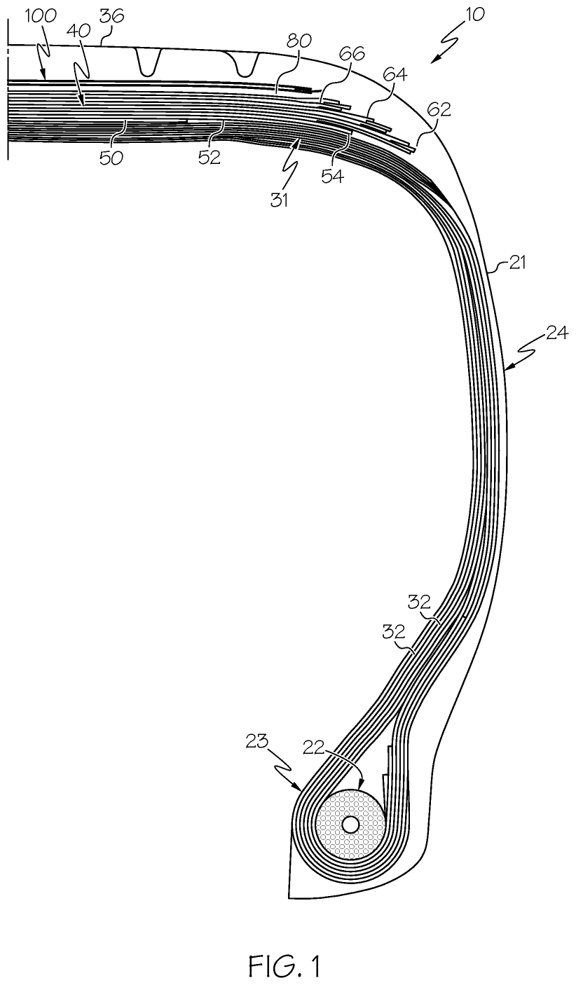

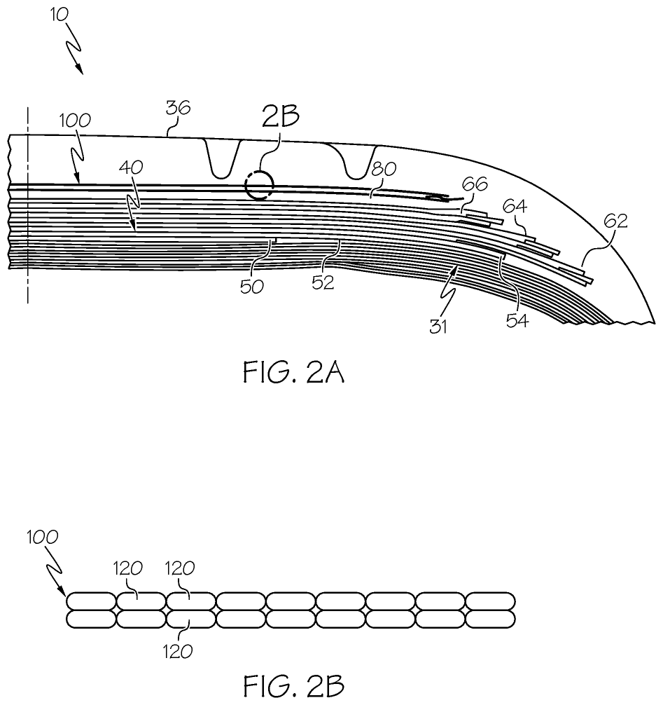

FIG. 1 illustrates a cross-sectional view of a first embodiment of a tire 10 of the present invention. The radial tire in this example is an aircraft tire, which includes a pair of bead portions 23 each containing a bead core 22 embedded therein, a sidewall portion 24 extending substantially outward from each of the bead portions 23 in the radial direction of the tire, and a tread portion 36 of substantially cylindrical shape extending between radially outer ends of these sidewall portions 24. Furthermore, the tire 10 is reinforced with a carcass 31 toroidally extending from one of the bead portions 23 to the other bead portion 23. The carcass 31 is comprised of at least two carcass plies 32, e.g., six carcass plies 32 in the illustrated embodiment. Among these carcass plies 32, four inner plies are wound around the bead core 22 from inside of the tire toward outside thereof to form turnup portions, while two outer plies are extended downward to the bead core 22 along the outside of the turnup portion of the inner carcass ply 32. Each of these carcass plies 32 contains many nylon cords such as nylon-6,6 cords extending substantially perpendicular to an equatorial plane E of the tire (i.e. extending in the radial direction of the tire).

A belt package 40 is arranged between the carcass 31 and the tread rubber 36 and is comprised of one or more belt plies 50,52, 54 preferably the radially innermost belts which are located near the carcass 31. Preferably, the one or more belt plies 50,52,54 are low angle belts, with a belt angle of 10 degrees or less, more preferably with a belt angle of 5 degrees or less. The low angle belts 50,52,54 may be formed of belt ply with parallel cords at a desired angle, i.e., belts with cut ends, or may be formed by helically winding a strip of one or more cords about the tire building drum to form a continuous belt with no cut ends. Preferably, the one or more low angle belts 50,52,54 increase in width from the radially innermost belt 50 to the radially outermost belt 54.

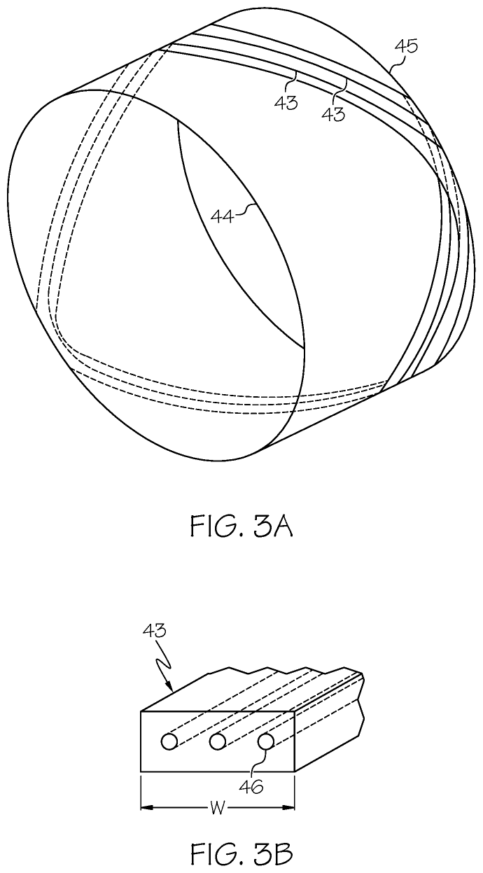

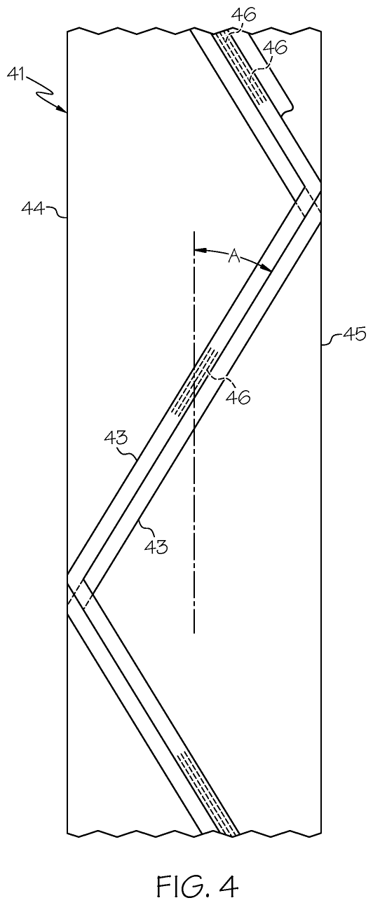

The belt package further includes one or more zigzag belt structures 62,64,66 located radially outward of the low angle belts 50,52,54. As shown in FIGS. 3 and 4, each of the radially outer zigzag belt structures is formed by winding a rubberized strip 43 of one or more parallel reinforcement cords 46 generally in the circumferential direction while being inclined to extend between side ends or lateral edges 44 and 45 of the layer forming a zigzag path and conducting such a winding many times while the strip 43 is shifted at approximately a width of the strip in the circumferential direction so as not to form a gap between the adjoining strips 43. As a result, the cords 46 of each strip 43 extend substantially zigzag in the circumferential direction while changing the bending direction at a turnaround point at both ends 44, 45 and are substantially uniformly embedded in the first inner zigzag belt structure 62 over a full region of the first inner zigzag belt structure. The cords 46 of the zigzag belt structures cross with each other at a cord angle A of 5 degrees to 40 degrees with respect to the equatorial plane of the tire when the strip 43 is reciprocated at least once between both side ends 44 and 45 of the ply within every 360 degrees of the circumference as mentioned above.

The strip of reinforcement cords 43 preferably has a width W, W being in the range of 0.2 to 1.5 inches. It is believed preferable that the strip width W should be 1.0 inch or less to facilitate bending to form the zigzag paths of the inner and outer layers 41, 42.

The radially outermost zigzag belt structure 66 is preferably the narrowest belt, wherein the belt edges extend over the sides of the belt edges of zigzag belt structures 64 and 62. The main belt layers are preferably formed from a hybrid or merged cord of nylon and aramid. More preferably, the main belt cord construction is 3000 d/2 aramid and 1680 d/1 nylon.

The tire further comprises an optional auxiliary belt layer 70 (not shown) located radially outward of the main belt package 40. The auxiliary belt layer 70 is preferably a zigzag belt layer formed of nylon cords having a 1890 d/4 or 1890 d/3 cord construction. The angle of the auxiliary belt layer may range from 0 degrees to 30 degrees. The auxiliary belt layer has a width less than the main belt layer 40, and the belt width is preferably in the range of 50% to 110% of the main belt width widest layer.

A cushion gum layer 80 is located radially outward of the auxiliary belt layer 70. The cushion gum layer 60 is formed from a stiff rubber compound, and preferably has a modulus of elasticity of 20-22 mpa.

A cut protector belt 100 is located radially outward of the cushion gum layer 80, and is the radially outermost belt. The cut protector belt 100 is preferably formed of a monofilament cord which is preferably nylon, preferably nylon MXD6 or nylon 6/6, and could also be a blend of nylon, nylon 6/6 or other organic materials. Preferably, the cut protector belt 100 is formed from 1 to four layers of monofilament cord, wherein the layers are formed so that they do not have cut ends. Thus, the cut protector belt may be formed of one or more zigzag belt structure which has two layers of cord that are interwoven together. The cut protector belt may also be formed of a helically wound belt layer that has no cut ends. The cut protector belt may comprise two zigzag belts forming four layers, or up to four helically wound layers. The cut protector belt may further comprise a zigzag belt structure in combination with 1-2 helically wound layers. The advantage of using the monofilament cord formed of nylon is that it is triple the strength and less gauge than conventional cord, allowing up to four layers of cord without significant weight penalty. The monofilament cord has a high lateral bending stiffness which makes it difficult for the cord to bend out of the way of a nail or other penetrating foreign object.

The cut protector belt 100 preferably has a width which extends from a first shoulder to a second shoulder, i.e., the full width of the tread. The cut protector belt is preferably a zigzag belt, formed by alternating the winding of the monofilament cord from one edge of the belt or drum to the other edge of the belt or drum, as shown in FIGS. 3 and 4. The angle of the monofilament in the zigzag belt may range from 1 degree to 45 degrees, and is more preferably in the range of 3 to 30 degrees, and most preferably in the range of 3 to 11 degrees. The cut protector belt may optionally include a low angle belt (not shown) formed of the monofilament cord, that may be helically wound to form a near zero degree belt layer. The low angle belt is preferably located radially inward of the cut protector belt 100, and preferably has a width to cover the middle ⅓ of the tread.

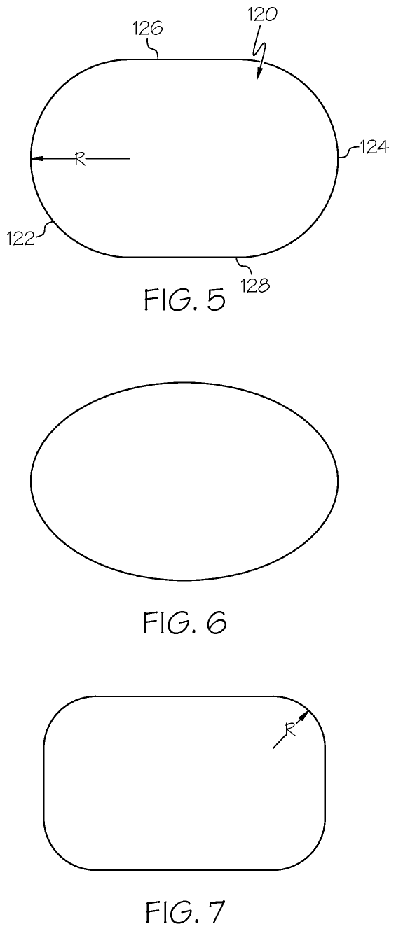

The monofilament nylon cord is preferably not round, and preferably has a flat cross-sectional profile. One preferred cross-sectional profile is obround, and is shown in FIG. 5. The obround cross-section has two semicircular sides 122,124 connected by flat upper and lower parallel surfaces 126,128. The obround monofilament preferably has a width in the range of 0.02 to 2 inches, and more preferably 0.03 to 0.1 inches. The monofilament cord width to height ratio is preferably in the range of 2 to 10, and more preferably in the range of 3-5. A monofilament that has an oval cross-sectional shape may be used, as shown in FIG. 6, and preferably has a width greater that its height. A monofilament that has a rectangular cross-sectional shape may be used as shown in FIG. 7, and preferably has a width greater than its height, with preferably radiused corners to avoid sharp edges. The larger width to height ratio increases the lateral bending stiffness, and can resist being pushed sideways by the penetrating object. Thus, having a flat monofilament such as obround, or rectangular helps catch the penetrating objects easier than a round cross-sectional shape, which typically allows the penetrating object to slide past it in order to escape penetration. Other cross-sectional shapes of the monofilament may also be used, that preferably are wide with a flat upper and/or lower surface. In order to improve the adhesion of the rubber to the filaments, it is preferred that the monofilaments are coated with a suitable adhesive such as RFL, and further coated with a rubber coating, such as belt or ply coat.

In one example of the present invention, a nylon 6/6 monofilament cord is used, having a construction of 4400/1 dtex. The cord width or horizontal gauge is 1.13 mm, while the vertical gauge is 0.38 mm. The cord LASE is 90 N at 7%, and a cord elongation of greater than 20% at cord breaking load of 300N. The cord is commercially available from Glassmaster and other manufacturers. In another example of the present invention, a PET polyester monofilament cord is used, having a construction of 1100/9 dtex, with a breaking strength of 650 N, and a gauge of 1.3.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire having a cut protector belt located radially outward of a main belt structure, wherein the cut protector belt is a zigzag belt structure formed by winding a monofilament cord from a first lateral edge to a second lateral edge in a zigzag manner to form an integrally formed dual (two) layer of cords, wherein the cross-sectional shape of the monofilament cord is not round.

2. The tire of claim 1 wherein the monofilament cord has a cross-sectional shape having a flat surface.

3. The tire of claim 1 wherein the monofilament cord has a width in the range of 0.02 inch to 2 inch.

4. The tire of claim 1 wherein the monofilament cord has a width greater than its height.

5. The tire of claim 1 wherein the monofilament cord has a height in the range of 0.005 inch to 0.200 inch.

6. The tire of claim 1 wherein the width to height ratio of the monofilament cord is in the range of 1 to 10.

7. The tire of claim 1 wherein the monofilament cord has a cross-sectional shape of obround.

8. The tire of claim 1 wherein the monofilament cord has a cross-sectional shape of rectangular with rounded corners.

9. The tire of claim 1 wherein the monofilament cord has a cross-sectional shape of oval.

10. The tire of claim 1 wherein the monofilament cord has a cross-sectional shape of elliptical.

11. The tire of claim 1 wherein the cut protector belt further comprises a helically wound belt of monofilament cord.

12. The tire of claim 1 wherein the helically wound belt is located radially inward of the zigzag belt structure.

13. The tire of claim 1 wherein the monofilament cord of the zigzag belt is angled in the range of 1 to 60 degrees.

14. The tire of claim 1 wherein the monofilament cord of the zigzag belt is angled in the range of 5 to 11 degrees.

15. The tire of claim 1 wherein the monofilament cord is nylon.

16. The tire of claim 1 wherein the monofilament cord is nylon 6/6.

17. A tire having a cut protector belt located radially outward of a main belt structure, wherein the cut protector belt is a zigzag belt structure formed by winding a monofilament cord from a first lateral edge to a second lateral edge in a zigzag manner to form an integrally formed two layer of cords, wherein the cross-sectional shape of the monofilament cord has a flat upper surface.

18. The tire of claim 17 wherein the width to height ratio of the monofilament cord is in the range of 1 to 10.

19. A tire having a cut protector belt located radially outward of a main belt structure, wherein the cut protector belt is formed by helically winding a monofilament cord, wherein the monofilament cord is formed of nylon, and wherein the cross-sectional shape is not round.

20. The tire of claim 19 wherein the width to height ratio of the monofilament cord is in the range of 1 to 10.
